(19) United States
(12) Patent Application Publication
(10) Pub. No.: US 2009/0042057 A1
(43) Pub. Date: Feb. 12, 2009

(54) Metal composite article and method of manufacturing

(75) Inventors: Julian Alex Thomas, Ridgway, PA (US); Timothy George Smith, St. Marys, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Springfield Munitions Company, LLC, Ridgway, PA (US)

(21) Appl. No.: 12/228,231

(22) Filed: Aug. 11, 2008

Related U.S. Application Data
(60) Provisional application No. 60/964,359, filed on Aug. 10, 2007.

(51) Int. Cl. B32B 15/01; B22F 7/04

(52) U.S. Cl. 428/665; 419/7

(57) ABSTRACT

A composite metal article includes a higher melting point metal, a lower melting point alloy and at least one other metal with an intermediate melting point between that of the higher melting point metal and the lower melting point alloy. The at least one other metal is selected to aid in sinter-densification of the higher melting point metal in a temperature range above the liquidus temperature of the lower melting point alloy and below the melting point of the at least one other metal.

### CROSS REFERENCE TO RELATED APPLICATIONS

This application claims benefit of U.S. Provisional Patent Application No. 60/964,359 entitled “Metal Composite Article and Method of Manufacturing” filed Aug. 10, 2007, which is hereby incorporated by reference in its entirety.

### BACKGROUND OF THE INVENTION

1. Field of the Invention

The present invention is directed generally to articles manufactured from a composite of metallic materials, e.g., powdered metal constituents, and in particular, and in one preferred and non-limiting embodiment, to an article, e.g., a projectile, manufactured from tungsten, nickel, iron and bronze constituents.

2. Description of Related Art

Presently, there is available a variety of articles formed from composites of various metals. Often, such articles are manufactured from the powder forms of such metals in a process that employs powder metallurgy. One such field of application for powdered metallurgy and the articles that are manufactured from such composites is in the production of projectiles, e.g., bullets, pellets, shot, ammunition, etc.

According to the prior art, bullets produced using composites of these metallic materials result in a high-density projectile. For example, as is taught in U.S. Pat. No. 7,232,473 to Elliott, provided is a high-density composite material comprising tungsten and bronze, which may be used to replace lead in the production of ammunition, weights and other high-density articles.

However, there remains a need in the art to provide composite materials that lead to additional and beneficial properties and qualities.

### SUMMARY OF THE INVENTION

It is, therefore, one object of the present invention to provide a composite metal article and method of manufacturing thereof that overcomes the drawbacks and the deficiencies of the prior art. It is a further object of the present invention to provide a composite metal article manufactured as a tungsten-nickel-iron-bronze article. It is another object of the present invention to provide a composite metal article and method of manufacturing thereof that is useful in the production of projectiles, ammunition, bullets, pellets, shot, weights and other similar products. It is a still further object of the present invention to provide a composite metal article and method of manufacturing thereof that is a high-density, tungsten-containing composition, which is prepared below the normal sintering temperatures for such articles.

Accordingly, provided is a composite metal article and method of manufacturing thereof, where the article comprises a composite of powdered metal materials. In one preferred and non-limiting embodiment, the composition includes: (1) a higher melting point metal with a density higher than the other constituents; (2) a lower melting point alloy; and (3) one or more other metals with intermediate melting points between that of the higher melting point metal and the lower melting point alloy. In another preferred and non-limiting embodiment the metal composite material comprises tungsten, nickel, iron and bronze.

More specifically, the present invention is directed to a composite metal article including a higher melting point metal; a lower melting point alloy; and at least one other metal with an intermediate melting point between that of the higher melting point metal and the lower melting point alloy. The at least one other metal is selected to aid in sinter-densification of the higher melting point metal in a temperature range above the liquidus temperature of the lower melting point alloy and below the melting point of the at least one other metal.

The higher melting point metal may be tungsten or any other suitable metal. The lower melting point alloy may be bronze or any other suitable alloy having a melting point lower than its base metal and higher than its alloying metal. The base metal of the lower melting point alloy may be soluble in or is a solvent for the at least one other metal with an intermediate melting point. If the lower melting point alloy is bronze, the base metal is copper and the alloying metal is tin. The at least one other metal may be at least one of the following: iron, nickel or any combination thereof.

The at least one other metal may have a degree of solubility in the lower melting point alloy once the lower melting point alloy has been substantially melted. At least a portion of the at least one other metal may remain out of solution of the melted lower melting point alloy once the lower melting point alloy has been substantially melted. Alternatively, the at least one other metal may substantially dissolve into the lower melting point alloy once it has been melted at an outer liquid boundary thereof, resulting in densification of the higher melting point metal due to a concentrated boundary layer of the at least one other metal in the melted lower melting point alloy. In still other embodiments, the at least one other metal may be fully dissolved and redistributed at an atomic level throughout the lower melting point alloy. The density of the higher melting point metal may be greater than the density of the lower melting point alloy and the at least one other metal.

The present invention is also directed to a method of manufacturing a composite metal article. The method includes the steps of mixing a higher melting point metal, a lower melting point alloy and at least one other metal with intermediate melting points between that of the higher melting point metal and the lower melting point alloy to create a mixture; combining this mixture with wax or polymer binders and heating the mixture to a temperature such that the binder melts; injection molding the heated mixture and cooling the molded material to form an article; and sintering the article. The higher melting point metal undergoes particle rearrangement due to a presence of the melted lower melting point alloy and simultaneous solid-state sinter densification.

The higher melting point metal may be tungsten or any other suitable metal. The lower melting point alloy may be bronze or any other suitable alloy having a melting point lower than its base metal and higher than its alloying metal. The base metal of the lower melting point alloy may be soluble in or is a solvent for the at least one other metal with an intermediate melting point. If the lower melting point alloy is bronze, the base metal is copper and the alloying metal is tin. The at least one other metal may be at least one of the following: iron, nickel or any combination thereof.

The at least one other metal may have a degree of solubility in the lower melting point alloy once the lower melting point alloy has been substantially melted. At least a portion of the at least one other metal may remain out of solution of the melted lower melting point alloy once the lower melting point alloy has been substantially melted. Alternatively, the at least one other metal may dissolve into the lower melting point alloy once it has been melted at an outer liquid boundary thereof, resulting in densification of the higher melting point metal due to a concentrated boundary layer of the at least one other metal in the melted lower melting point alloy. In still other embodiments, the at least one other metal may be fully dissolved and redistributed at an atomic level throughout the lower melting point alloy.

In addition, the present invention is directed to a projectile including a mixture of a higher melting point metal, a lower melting point alloy and at least one other metal with intermediate melting points between that of the higher melting point metal and the lower melting point alloy. The at least one other metal is selected to aid in sinter-densification of the higher melting point metal in a temperature range above the liquidus temperature of the lower melting point alloy and below the melting point of the at least one other metal.

These and other features and characteristics of the present invention, as well as the methods of operation and functions of the related elements of structures and the combination of parts and economies of manufacture, will become more apparent upon consideration of the following description. As used in the specification and the claims, the singular form of “a”, “an”, and “the” include plural referents unless the context clearly dictates otherwise.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a photomicrograph of a pre-blended tungsten-nickel-iron powder utilized in the present invention;

FIG. 2 is a photograph of shot comprising a tungsten-bronze-nickel-iron composite in accordance with a first embodiment of the present invention;

FIG. 3 is a photomicrograph of the shot of FIG. 2 magnified at 200 times;

FIG. 4 is a photomicrograph of the shot of FIG. 2 magnified at 1000 times;

FIG. 5 is a photomicrograph of the shot of FIG. 2 showing six versions of the same image, each highlighting a different element and one showing the original image;

FIG. 6 is a photomicrograph of shot comprising a tungsten-bronze-nickel composite in accordance with a second embodiment of the present invention magnified at 200 times;

FIG. 7 is a photomicrograph of the shot of FIG. 6 magnified at 1000 times;

FIG. 8 is a photomicrograph of shot comprising a tungsten-bronze-nickel-iron composite in accordance with a third embodiment of the present invention magnified at 200 times; and

FIG. 9 is a photomicrograph of the shot of FIG. 8 magnified at 1000 times.

### DETAILED DESCRIPTION OF THE PRESENT INVENTION

Other than in the operating examples or where otherwise indicated, all numbers or expressions referring to quantities of ingredients, reaction conditions, etc., used in the specification and claims are to be understood as modified in all instances by the term “about”. Various numerical ranges are disclosed in this patent application. Because these ranges are continuous, they include every value between the minimum and maximum values. Unless expressly indicated otherwise, the various numerical ranges specified in this application are approximations.

According to the present invention, provided is a composite of powder origin. This composite includes: (1) a higher melting point metal with a density higher than the other constituents; (2) a lower melting point alloy; and (3) one or more other metals with intermediate melting points between that of the higher melting point metal and the lower melting point alloy. Further, it is preferable that the other metal or metals have some degree of solubility in the lower melting point alloy, wherein the level or degree of solubility and/or rate of diffusion is controlled by the alloy composition and the choice of other metals. The recitation “lower melting point alloy” is simply meant to indicate that this alloy exhibits a melting point that is lower than the higher melting point metal(s) and the other metals and not an indication of a specific range for the melting point.

In one preferred and non-limiting embodiment, the lower melting point alloy has a melting point lower than its base metal and higher than its alloying metal and the base metal of the alloy is soluble in or is a solvent for at least one of the intermediate melting point metal(s).

The other metal or metals significantly aid in sinter-densification of the higher melting point metal in a temperature range above the liquidus temperature of the lower melting point alloy, but below the melting temperature of the other metal or metals and that below the alloy liquidus temperature the effect of activation is substantially lower or not present at all. For purposes of this discussion, the liquidus temperature is the temperature for a material at which there is complete liquid, without any solids of the alloy metals present although other dissolved solids may be in solution.

In addition, either a portion of the other metal or metals remains out of solution of the lower melting point alloy, or the other metal or metals dissolves into the lower melting point alloy at the outer liquid boundary or the other metal or metals is fully dissolved and re-distributed at an atomic level throughout the lower melting point alloy. In either, case this results in rapid densification of the higher melting point metal due to the concentrated boundary layer or intimate contact of other metal or metals with the higher melting point metal due to the enhanced mobility of other metal or metals in the liquid.

In one preferred and non-limiting embodiment, the described composite article is produced according to a process that represents a new approach for preparing near full density tungsten-containing compositions far below the normal sintering temperature for materials of similar compositions. One mode of this invention includes the sintering of selected powdered metal components, including a mixture of metal-injection-molded tungsten, nickel, iron and pre-alloyed bronze powders. The tungsten undergoes high levels of particle rearrangement and significant bonding due to the presence of a liquid during sintering and simultaneous solid-state sinter-densification at a rate much higher than would occur with typical compositions of similar materials in this temperature range. This is due to the solubility of the nickel and iron in the liquid bronze, which makes these elements more readily available for solid tungsten particle sintering activation. This is compared to copper liquid which dissolves the nickel and iron more slowly and at a higher temperature and without the atomic level redistribution of these elements within the liquid which makes these metals less available at the tungsten surface. It is reasonable to transfer this basic concept to other materials and to other various ratios within the specific materials of the preferred embodiment.

Table 1 provides typical peak sintering temperatures for similar tungsten containing alloys, and the approximate temperature at which the first liquid is present.

TABLE 1

| | | Typical sintering |
|---|---|---|
| | First liquid | temperature (° F.) to |
| Materials | (° F.) | reach 95-98% of theoretical density |
| Tungsten-copper | 1984 | 2460 |
| Tungsten-nickel- | 1984 | 2550 |
| copper | | |
| Tungsten-nickel-iron | 2669 | 2730 |
| *Tungsten-nickel-iron- | 1860 | 2030 |
| bronze | | |

*One composition of the current invention

One benefit of processing using a low sintering temperature is that sintering costs can be greatly reduced by use of belt furnaces rather than high temperature pusher furnaces. This is an unprecedented processing enhancement over the prior art for materials of similar final density, and will open up new markets previously unavailable due to the high cost of sintering similar density materials. The main target application for this material is for high performance non-lead shot. Many other potential applications exist considering the high density and low manufacturing cost, as compared to similar tungsten-based compositions, including, but not limited to, military, automotive and sporting goods applications. These materials can be formed into parts by any standard metal powder processing method, therefore, there are few limitations on what types of shapes can be produced.

The invention will now be described by the following examples. The examples are intended to be illustrative only and are not intended to limit the scope of the invention.

### MATERIALS USED IN EXAMPLES

The metallic materials used in all the examples were commercially available powders below 325 mesh size (45 microns) such as those typically used for Metal Injection Molding (MIM).

Tungsten

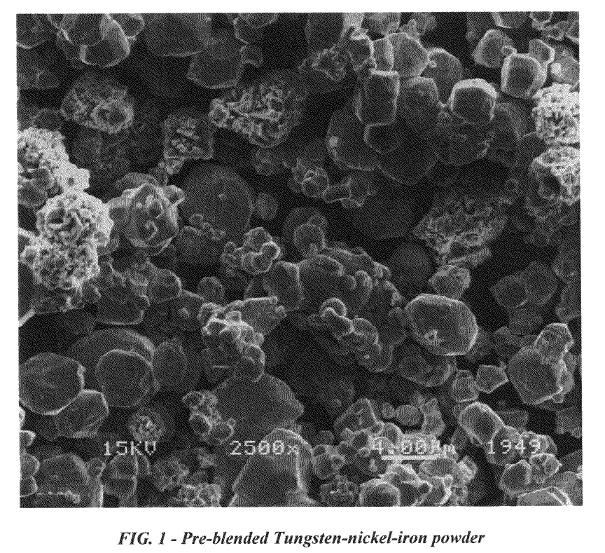

The tungsten types were of two slightly different particle sizes: 4-8 micron from Continuous Metal Technology (CMT), 439 West Main Street, Ridgway, Pa. [with carbonyl iron and carbonyl nickel powders added to a final composition of 90% tungsten, 8% nickel,and 2% iron] and a milled 8-10 micron powder from ATI Alldyne, 7300 Highway 20 West, Huntsville, Ala. In all cases where the tungsten is described as 4-8 micron, the material is from CMT and the composition is adjusted to the levels indicated by the addition of the remaining constituent materials. For ease of reading and to prevent confusion the individual elements are thus listed separately in the descriptions although certain portions may have been added as a pre-blended mixture. FIG. 1 is an image of the CMT pre-blended tungsten-nickel-iron material taken with a scanning electron microscope.

Bronze

The bronze powder is a standard grade of commercially available spherical powder (Grade 5890) from ACuPowder International, 901 Lehigh Avenue, Union, N.J.

Carbonyl Iron

The carbonyl iron powder (if not added as part of the CMT pre-blended material) was grade R-1470 from ISP, 1361 Alps Road, Wayne, N.J.

Carbonyl Nickel

The nickel powder (if not added as part of the CMT pre-blended material) was grade 123 from INCO Powders.

### SINTERING ATMOSPHERE USED IN THE FOLLOWING EXAMPLES

The following is a description of the sintering atmosphere used in the Examples described hereinafter. It should be noted that this description is for exemplary purposes only and other suitable sintering atmospheres may be utilized. Accordingly, the following description is not to be construed as limiting the present invention.

In addition to holding for a period of time at the tungsten oxide reduction temperature to remove the majority of oxides prior to pore closure it is also well documented that limiting the reduction potential in the final high temperature sintering zones is useful in eliminating reduction-induced pores. This is typically achieved by adding moisture to the hydrogen prior to injection into the high temperature zones by percolating it through water in a device commonly known as a “bubbler”. The effect of the moisture is to shift the balance between reduction and oxidation which is monitored by measuring the dew-point of the sintering atmosphere. The optimal situation exists wherein “dry” hydrogen (with low moisture content) is injected into the zones at the lower oxide reduction temperature, below a temperature where significant pore closure has begun to enhance the reduction of these oxides and removal of the gaseous water vapor by-product through the open porosity. This is followed by the introduction of “wet” hydrogen with a controlled dew-point in the high temperature zones to inhibit reduction. It is also significant to note that the control of reduction potential in the final sintering zones is also affected by the balance of hydrogen to other process gasses such as nitrogen. It is also significant to note that the control of the dew-point is also useful in controlling the removal of carbon-based binders in the lower temperature regions of the furnace. The specific dew-points will vary depending on the details of the materials being processed; however, the samples produced in all the following examples were processed in the temperatures, atmospheres and dew-points provided in Table 2. It should be reinforced that these are not necessarily optimal levels and simply are the conditions reported for these samples.

TABLE 2

| | Pre-heat section | High-heat section |
|---|---|---|
| Temperature ° F. | 800-1000 | 2000-2030 |
| Atmosphere | 75% hydrogen 25% nitrogen | 75% hydrogen 25% |
| | | nitrogen |
| Dew-point ° F. | 50-60 | 50-60 |

### Example 1

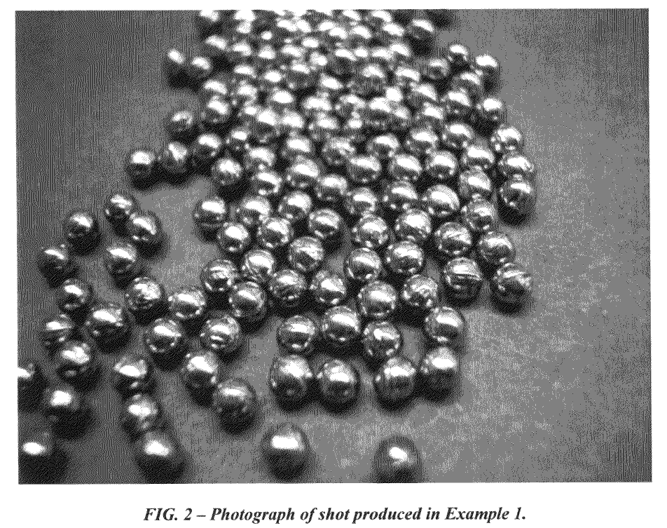

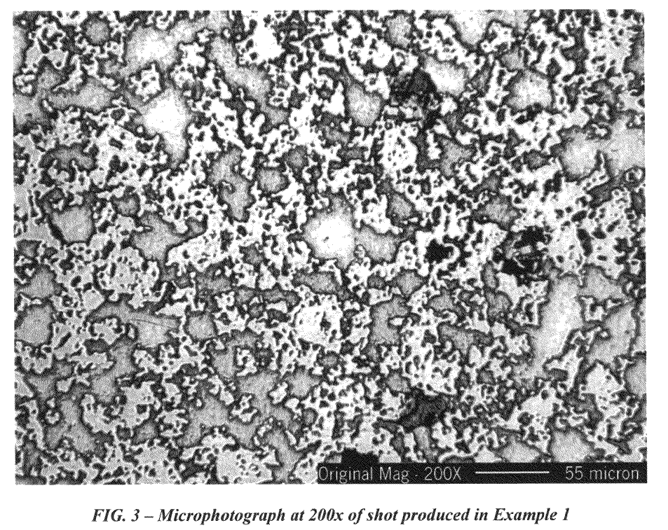

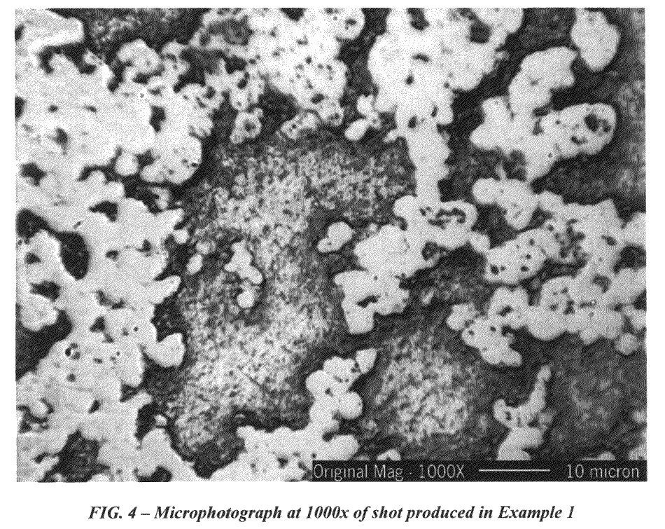

According to one preferred and non-limiting embodiment, a test was performed to illustrate one method by which this composition can be processed. A powdered metal mixture comprising 63% tungsten (4-8 micron), 30% 90-10 copper-tin pre-alloyed bronze, 5.6% nickel and 1.4% iron was combined at 55% by volume with a paraffin wax-based binder system containing 92.5% paraffin wax, 5% carnauba wax and 2.5% stearic acid. This mixture was heated to melt the binders, mixed and subsequently granulated to form particles suitable for using as injection molding feedstock. The feedstock was then injection molded into shot pellets with a diameter of 0.173 inches. Sintering was performed in a belt furnace with five zones (approximately five feet per zone) with the belt speed at 0.8 inches per minute. Shot pellets were packed in an alumina powder for support and to aid in binder removal. The peak temperature was 2030° F. (1110° C.), and the atmosphere consisted of 75% hydrogen and 25% nitrogen. FIG. 2 shows a small sample of the shot produced in Example 1. FIG. 3 shows the microstructure at 200× of the shot produced in Example 1. FIG. 4 shows the microstructure at 1000× of the shot produced in Example 1. The final properties of the shot after sintering are as follows:

| Density: | 12.7 g/cm² (95% theoretical) |
|---|---|
| Hardness: | 91 Rockwell 15T |
| Linear shrinkage: | 16.65% |

In addition, the shot produced using the method of Example 1 included shot of various sizes. The sizes of the shot produced using the method of Example 1 are set forth in Table 3 produced hereinafter.

TABLE 3

| | Nominal | |
|---|---|---|
| Shot size | green diameter (inches) | Nominal sintered diameter (inches) |
| 2 | 0.173 | 0.145-0.150 |
| 4 | 0.150 | 0.125-0.130 |
| 6 | 0.127 | 0.105-0.110 |

SEM Elemental Mapping

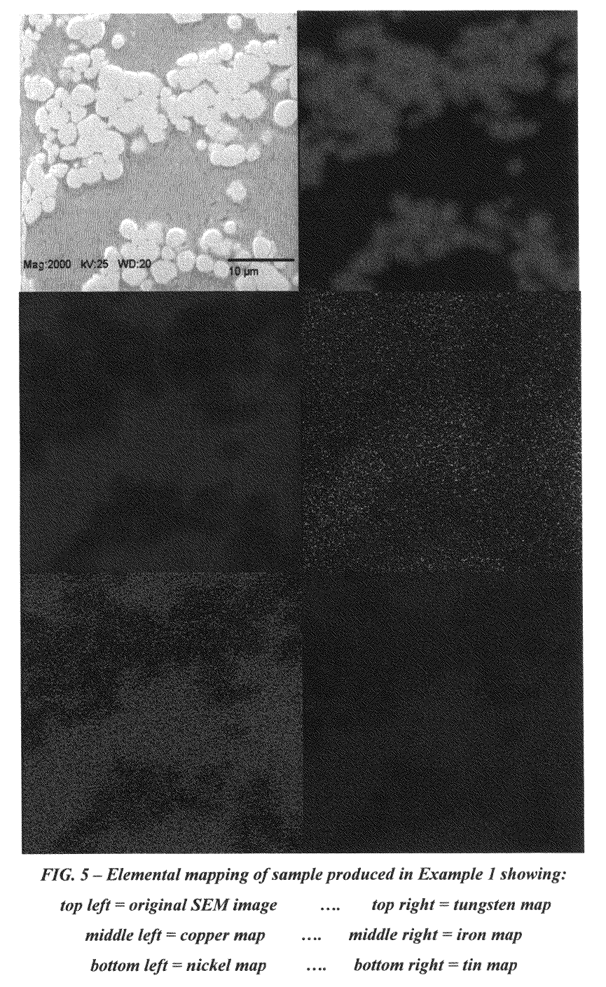

Elemental mapping was performed on a cross-sectioned sample of shot from Example 1 using a scanning electron microscope configured with X-ray diffraction. The analysis indicates an atomic scale level of diffusion unprecedented in similar materials in this temperature range. The nickel has been fully dissolved in the copper-tin liquid and is thus available for sintering activation of the tungsten along all tungsten grain boundaries in contact with the liquid. It is further observed that the iron is not selectively concentrated along the tungsten-liquid grain boundaries as one would expect and as shown in the '473 patent. It is further hypothesized that the nickel, copper and tin are decomposing into a spinodal microstructure during thermal treatment due to the isomorphic nature of copper and nickel. This allows the liquid to solidify with nickel in place of copper at any location within the microstructure without a resulting crystallographic dislocation. The level of rearrangement and dispersion of the nickel clearly demonstrates the high level of diffusion present in this materials system. FIG. 5 shows six versions of the same image, each highlighting a different element and one showing the original image. More specifically, the image in the upper left hand corner is a photomicrograph of the shot in FIG. 2, the image in the upper right hand corner highlights the tungsten content, the image in the center left hand side highlights the copper content, the image in the center right hand side highlights the iron content, the image in the bottom left hand corner highlights the nickel content and the image in the bottom right hand corner highlights the tin content.

In addition, the article produced using the method of Example 1 was evaluated with both optical and SEM microscopy as well as X-ray diffraction. Several notable findings were revealed including evidence of significant tungsten sintering within the liquid matrix and a very homogeneous distribution of the iron and nickel throughout the microstructure in the sub-micron size range. Both microstructural evaluations show that the elemental iron and nickel powder particles are completely dissolved and redistributed throughout both the matrix and the tungsten interstitial spaces. This differs from the description previously hypothesized in that the distribution is uniform rather than concentrated at the grain boundaries. The remarkable finding is the homogeneity of the distribution of the iron and nickel that differs significantly from the prior art produced in the same temperature range. The homogeneity indicates that the bronze is forming a new alloy either as a solid solution or otherwise with the iron and nickel in-situ during sintering. It appears that a finely distributed homogenous microstructure is forming, possibly spinodal in nature and with a uniform ordered crystalline structure. While it is quite possible that variants of this multi-metal concept concentrate the sintering activator at the grain boundaries and this mode is still considered significant to this invention, the findings of this investigation indicate otherwise for this mode of the invention. This example does however form a new alloy and it is this alloy formation that is responsible for the distribution of the activator metals. In either case the result is a high degree of contact between the high melting point material and the intermediate melting point metal(s) (activators) as a result of this atomic rearrangement of the intermediate melting point metal(s) leading to enhanced sinter densification at relatively low temperature due to the shortening of distances between the high melting point particles providing active atomic diffusion pathways, and by the presence of a persistent liquid phase. In either case the alloy formation between the intermediate melting point metals and the lower melting point alloy is the control mechanism responsible for the enhanced activation.

In Example 1, as well as the remaining examples described hereinafter, the core concept of the alloying of the intermediate melting point metals with the lower melting point alloy(s) to create a favorable arrangement of the intermediate melting point metals with a resulting reduction in processing (sintering) temperature is critical.

Following elemental mapping as described hereinabove it is shown that the nickel has been completely dissolved and redistributed homogeneously in the bronze. The iron has also been dissolved, however it appears that the distribution is less homogeneous in the bronze itself. Regardless, both nickel and iron are exceptionally mobile within the liquid and are readily available at all tungsten surfaces in contact with the liquid. In addition due to the near continuous presence of both nickel and/or iron within the liquid it is possible that tungsten atoms could be transported through the liquid along pathways of nickel and or iron.

### Example 2

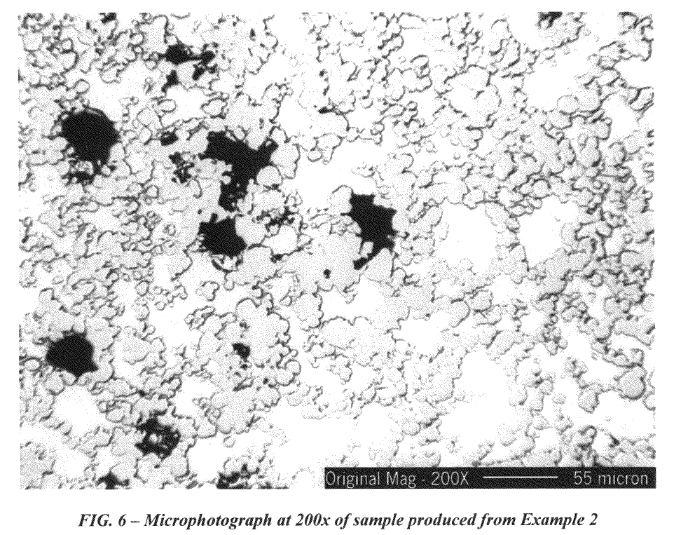

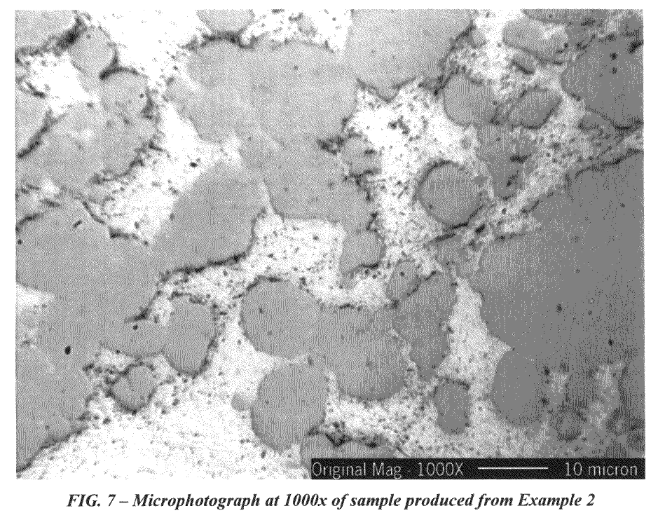

A second test was performed to illustrate alternative materials such as a similar composition without iron. A powdered metal mixture comprising 63% tungsten (8-10 micron), 30% 90-10 copper-tin pre-alloyed bronze and 7% nickel was combined at 52% by volume with a paraffin wax-based binder system containing 92.5% paraffin wax, 5% carnauba wax and 2.5% stearic acid. This mixture was heated to melt the binders, mixed and subsequently granulated to form particles suitable for using as injection molding feedstock. The feedstock was then injection molded into shot pellets with a diameter of 0.173 inches. Sintering was performed in a belt furnace with five zones (approximately five feet per zone) with the belt speed at 0.8 inches per minute. Shot pellets were packed in an alumina powder for support and to aid in binder removal. The peak temperature was 2030° F. (1110° C.), and the atmosphere consisted of 75% hydrogen and 25% nitrogen. FIG. 6 shows the microstructure of Example 2 at 200× magnification. FIG. 7 shows the microstructure of Example 2 at 1000×. The final properties of the shot after sintering are as follows:

| Density: | 12.11 g/cm² (90.1% theoretical) |
|---|---|
| Hardness: | 88 Rockwell 15T |
| Linear shrinkage: | 16.7% |

### Example 3

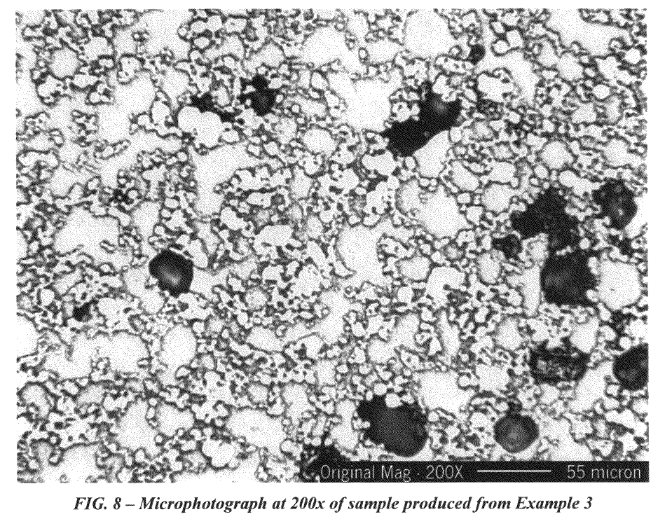

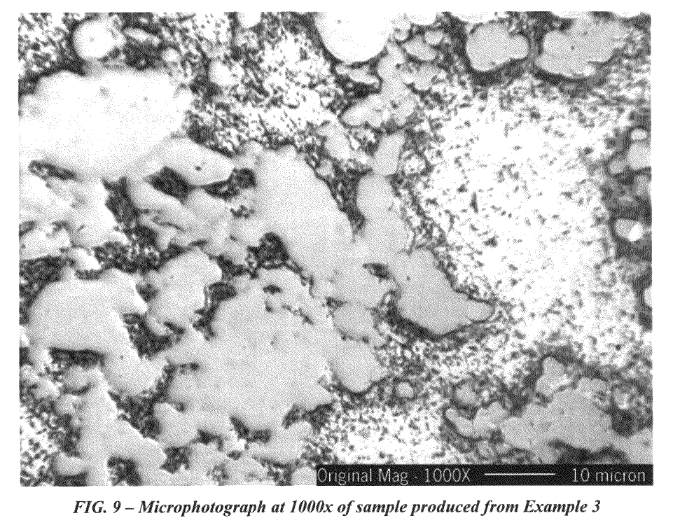

A third test was performed to illustrate the use of a similar composition with lower tungsten content. A powdered metal mixture comprising 54.6% tungsten (50-50 both tungsten types), 36.76% 90-10 copper-tin pre-alloyed bronze, 2.34% nickel and 1.04% carbonyl iron was combined at 52% by volume with a paraffin wax-based binder system containing 92.5% paraffin wax, 5% camauba wax and 2.5% stearic acid. This mixture was heated to melt the binders, mixed and subsequently granulated to form particles suitable for using as injection molding feedstock. The feedstock was then injection molded into shot pellets with a diameter of 0.173 inches. Sintering was performed in a belt furnace with five zones (approximately five feet per zone) with the belt speed at 0.8 inches per minute. Shot pellets were packed in an alumina powder for support and to aid in binder removal. The peak temperature was 2030° F. (1110° C.), and the atmosphere consisted of 75% hydrogen and 25% nitrogen. FIG. 8 shows the microstructure of the sample produced in Example 3 at 200× magnification. FIG. 9 shows the microstructure of the sample produced in Example 3 at 1000× magnification. The final properties of the shot after sintering are as follows:

| Density: | 11.24 g/cm² (87.5% theoretical) |
|---|---|
| Hardness: | 74 Rockwell 15T |
| Linear shrinkage: | 16% |

### ADDITIONAL EXAMPLES

Many additional examples are conceivable within the basic framework set by the aforementioned critical features of the present invention. These additional examples could include material combinations with differing melting points, compositions, and discreet mechanisms of diffusion and solubility of the other metals within the lower melting point alloy. It is understood that solubility limits of the other metals and alloy composition and melting range of the liquid will define useful ranges within any one group of materials. For example, with the preferred compositional elements, as the percentage of tin increases in the pre-alloyed bronze, the nickel will have lower solubility in the liquid. However, at the same time, the higher tin concentration decreases the melting range of the bronze alloy which may allow for earlier diffusion of the nickel into the liquid. It is also understood that depending on the materials selected for the other metals and lower melting point alloy a wide range of varying events and microstructures are possible during liquid formation and the presence of the liquid and subsequently on cooling and solidification. The specific utility of these events and microstructures in providing controlled activation in the presence of the lower melting point alloy liquid and the properties resulting from the microstructure after solidification are indeed a main object of the current invention. The following additional examples describe some of the possible combinations and alternatives to the preferred composition.

One class of combinations could enhance the early onset of sinter-densification such as substituting nickel or iron with cobalt. Cobalt is not soluble in bronze liquid and, therefore, would tend to segregate to the grain boundaries of the higher melting point metal due to displacement by mass transport of the liquid and rearrangement of higher melting point metal particles. Cobalt is an excellent activator for tungsten and other similar high melting point metals, such as those that could be substituted for tungsten depending on the requirements of the particular application.

Further combinations are possible to enhance diffusion bonding and rearrangement of the higher melting point metal by the use of any number of alternative other metals with a melting point lower than tungsten. In the case where tungsten is used as the primary high melting point metal for example, molybdenum powder could be combined with tungsten to enhance solubility in the nickel at a slightly lower temperature than tungsten, thereby initiating diffusion at a slightly lower temperature. This initiation can aid in the densification of the tungsten by creating diffusion pathways through tungsten rich regions that enhance the probability of tungsten diffusion.

Still further possible combinations include substituting pre-alloyed bronze with any number of alloys of copper and nickel, or copper-nickel alloys containing other alloying metals such as tin. Such alloys could include, but are not limited, to those classified as spinodal alloys. Alloys of differing melting ranges and final properties would be useful in modifying the onset of sintering activation and mass transport to different temperature levels. In some cases it could be useful to raise the onset temperature in order to avoid a particular region of interest, such as the reduction temperature for the oxides present on the surfaces of the higher melting point metals. It is well documented in tungsten alloy systems that when heating tungsten in a reducing hydrogen atmosphere it is beneficial to include a hold time at approximately 1472° F. (800° C.) to reduce the oxides prior to sintering activation and prior to pore-closure during densification. If the oxides remain once the open network of pores is eliminated, the oxides combine with hydrogen forming larger water vapor molecules, which if too large to diffuse out of the material will become trapped and expand as the temperature increases further. These trapped water vapor pockets are evident in the final microstructure as round pores. The main advantage of reducing porosity in this manner is the corresponding gain in density resulting in performance gains and greater cost advantage where high density is desirable; otherwise, there are no specific limitations or requirements implied with respect to the current invention, and that this method of pore control is presented as relevant to this invention.

It is further proposed that varying the ratios of nickel, copper and tin in the composite metal article of the present invention could lead to improved spinodal decomposition providing enhanced physical and corrosion properties. Although the preferred embodiment has shown excellent resistance to corrosion in distilled water over extended periods, it is conceivable that, specifically for use as shot, the corrosion resistance may require further enhancement. In addition, this fine tuning of the final microstructure by adjusting composition could be advantageous in mechanical applications, such as balancing weights for rotors and other applications requiring specific mechanical properties. Further, specifically for applications of frangible projectiles, it is necessary to make adjustments that affect the yield strength and high strain rate shear behavior of the material to achieve the correct level of frangibility depending on the application. To a large extent the properties and microstructures found to provide the desired degree of frangibility will be affected by the choice of composition and also sintering conditions. It is also understood that specific density levels will be required depending on the application for frangible or fragmenting projectiles, and that the density is also predominantly linked to the composition and degree of sinter-densification.

It is further conceived that beneficial results could be obtained by adding a second alloy metal with a melting temperature lower than the intermediate melting point metals. For example, the combination of an alloy of copper-tin and one of copper-nickel may be advantageous. In addition, the composition of the lower melting point alloys need not be in the arrangement of the higher melting point metal of the alloy present as the majority constituent. For example, the use of copper-nickel alloys with the majority of the alloy being copper may be advantageous.

Furthermore, the high melting point metal need not be limited to single metallic elements, but could be extended to include carbides, borides and other similar materials or alloys. Of particular interest are materials such as tungsten carbide, vanadium carbide and chrome carbide which could extend the useful range of products provided by a material produced in this manner at a lower cost and significantly expand the commercial applications possible with the present invention. Also, the high melting point metal need not be limited to a single metal. For example, the use of combinations of tungsten and rhenium or other materials may be beneficial for certain applications.

Further applications for the composite metal article of the present invention have also been conceived. Additional applications include, but are not limited to, fishing sinkers and other fishing components, shaped charge liners, penetrating ammunition components, wear plates, thermal management device components, inertia components such as those used in golf clubs, cell phone vibrator weights, gyroscope system components and various other applications.

It has also been envisioned that additional forming methods including casting are possible with certain formulations. It is possible, however, that such forming methods would rely on starting with powdered materials in order to achieve the unique advantages described by the present invention.

Furthermore, certain additions could be made in the form of oxides which are reduced in-situ during the sintering process. Examples of such additions are fine powders of molybdenum oxides, tungsten oxides, iron oxides, nickel oxides, oxides of other metals, etc. The use of such oxides provides a route for introducing very fine powders that might be difficult to obtain as metallic powders, or may be in a favorable size range.

The present invention results in various benefits and features when compared with the processes and articles produced according to the prior art. For example, one difference between the presently-invented article and the tungsten-bronze article of the '473 patent is that, with the article produced according to the '473 patent, only a single activator for the tungsten (iron) is utilized, while with the presently-invented article, two such activators, e.g., nickel and iron, are used. Therefore, the level of each metal, individually, is higher than the optimal iron level for tungsten-bronze densification to obtain a comparable percentage of theoretical density after sintering.

According to certain conducted tests, the tungsten-bronze system of the prior art shows the peak benefit of iron addition to be at a very narrow range around 0.8%. Any and all interactions are related to time at temperature, peak temperature, sintering atmosphere, concentrations of each metal, alloy composition, etc. Therefore, the present invention should not be limited to the specific metals discussed herein. Other appropriate and selected metal materials and composites or variations of the levels of the materials of the preferred embodiment can be used to achieve the same high-density or near-fully dense articles described herein. In addition, the metal materials (or amounts thereof) may be selected to achieve articles of higher or lower density dependent upon the application or required end product.

In addition, the metal composite article and system of the present invention use a novel dual-function alloying and activation process, which provides for enhanced sinter-densification at significantly higher tungsten levels (as opposed to the tungsten-bronze system), and at much lower processing temperatures according to the general prior art. While presently iron may be used in manufacturing the presently-invented article (as described herein), the use of this constituent may not be required to achieve these novel benefits.

Several additional material systems have been considered for further investigation that embody the concept of the present invention. These modes incorporate different metal combinations that fall into the basic arrangement of a higher melting point metal with a density higher than the other constituents, a lower melting point alloy and one or more other metals with intermediate melting points between that of the higher melting point metal and the lower melting point alloy in which the formation of a new alloy of the intermediate metal(s) and lower melting point alloy is used as a mechanism for activation of the high melting point metal. For the purpose of illustrating various alternative material systems, the following non-limiting partial listing of such materials is provided as Table 5 with any combinations possible within the scope of the described invention as well as many others not listed which are also possible:

TABLE 5

| | Intermediate | |
|---|---|---|
| High density, high M.P. | metals | Lower M.P. alloy |
| Tungsten | Nickel | Copper-tin bronze |
| Molybdenum | Cobalt | Copper-nickel |
| Rhenium | Iron | Copper-aluminum |
| Tantalum | Manganese | Copper-nickel-tin |
| Osmium | Titanium | Copper-zinc |

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope hereof. For example, it is to be understood that the present invention contemplates that, to the extent possible, one or more features of any embodiment can be combined with one or more features of any other embodiment.

The invention claimed is:

1. A composite metal article comprising:
a higher melting point metal;
a lower melting point alloy; and
at least one other metal with an intermediate melting point between that of the higher melting point metal and the lower melting point alloy,
wherein the at least one other metal is selected to aid in sinter-densification of the higher melting point metal in a temperature range above the liquidus temperature of the lower melting point alloy and below the melting point of the at least one other metal.

2. The composite metal article of claim 1, wherein the higher melting point metal is tungsten.

3. The composite metal article of claim 1, wherein the lower melting point alloy is bronze.

4. The composite metal article of claim 3, wherein the lower melting point alloy has a melting point lower than its base metal and higher than its alloying metal.

5. The composite metal article of claim 4, wherein the base metal of the lower melting point alloy is soluble in or is a solvent for the at least one other metal with an intermediate melting point.

6. The composite metal article of claim 4, wherein the base metal is copper and the alloying metal is tin.

7. The composite metal article of claim 1, wherein the at least one other metal is at least one of the following: iron, nickel or any combination thereof.

8. The composite metal article of claim 1, wherein the at least one other metal has a degree of solubility in the lower melting point alloy once the lower melting point alloy has been substantially melted.

9. The composite metal article of claim 1, wherein at least a portion of the at least one other metal remains out of solution of the melted lower melting point alloy once the lower melting point alloy has been substantially melted.

10. The composite metal article of claim 1, wherein the at least one other metal substantially dissolves into the lower melting point alloy once it has been melted at an outer liquid boundary thereof, resulting in densification of the higher melting point metal due to a concentrated boundary layer of the at least one other metal in the melted lower melting point alloy.

11. The composite metal article of claim 1, wherein the at least one other metal is fully dissolved and redistributed at an atomic level throughout the lower melting point alloy.

12. The composite metal article of claim 1, wherein the density of the higher melting point metal is greater than the density of the lower melting point alloy and the at least one other metal.

13. A projectile at least partially formed from the composite metal article of claim 1.

14. A method of manufacturing a composite metal article, comprising:
mixing a higher melting point metal, a lower melting point alloy and at least one other metal with an intermediate melting point between that of the higher melting point metal and the lower melting point alloy to create a mixture;
combining the mixture with at least one of a wax binder and a polymer binder to create a resulting mixture and heating the resulting mixture to a temperature such that the at least one wax binder and polymer binder melts;
injection molding the heated mixture to form an article; and
sintering the article, wherein the higher melting point metal undergoes particle rearrangement due to a presence of the melted lower melting point alloy and simultaneous solid-state sinter-densification.

15. The method of claim 14, wherein the article is a projectile.

16. The method of claim 14, wherein the higher melting point metal is tungsten.

17. The method of claim 14, wherein the lower melting point alloy is bronze.

18. The method of claim 17, wherein the lower melting point alloy has a melting point lower than its base metal and higher than its alloying metal.

19. The method of claim 18, wherein the base metal of the lower melting point alloy is soluble in or is a solvent for the at least one other metal with an intermediate melting point.

20. The method of claim 18, wherein the base metal is copper and the alloying metal is tin.

21. The method of claim 14, wherein the at least one other metal is at least one of the following: iron, nickel or any combination thereof.

22. The method of claim 14, wherein the at least one other metal has a degree of solubility in the lower melting point alloy once the lower melting point alloy has been substantially melted.

23. The method of claim 14, wherein at least a portion of the at least one other metal remains out of solution of the melted lower melting point alloy once the lower melting point alloy has been substantially melted.

24. The method of claim 14, wherein the at least one other metal dissolves into the lower melting point alloy once it has been melted at an outer liquid boundary thereof, resulting in densification of the higher melting point metal due to a concentrated boundary layer of the at least one other metal in the melted lower melting point alloy.

25. The method of claim 14, wherein the at least one other metal is fully dissolved and redistributed at an atomic level throughout the lower melting point alloy.

26. A projectile, comprising:
a mixture of a higher melting point metal, a lower melting point alloy and at least one other metal with an intermediate melting point between that of the higher melting point metal and the lower melting point alloy,
wherein the at least one other metal is selected to aid in sinter-densification of the higher melting point metal in a temperature range above the liquidus temperature of the lower melting point alloy and below the melting point of the at least one other metal.
